(19) United States
(12) Patent Application Publication
(10) Pub. No.: US 2001/0041559 A1
(43) Pub. Date: Nov. 15, 2001

(54) Reactive recording of conversation

(76) Inventor: Atanas Salabaschew, Remchingen (DE)

Correspondence Address: LOWE HAUPTMAN GILMAN & BERNER, LLP, 1700 Diagonal Road, Suite 310, Alexandria, VA, 22314, US

(21) Appl. No.: 09/748,202

(22) Filed: Dec. 27, 2000

(30) Foreign Application Priority Data
Dec. 29, 1999 (DE) 199 63 630.3

(51) Int. Cl. H04B 1/38

(52) U.S. Cl. 455/412; 455/550

(57) ABSTRACT

The invention relates to a method for recording conversations and/or fragments of conversation during a cell-phone conversation, said cell phone comprising an appropriate storage unit fitted with a writable, scrolling memory which is loaded at cycles of specified resets, the memory content being overwritten after one cycle.

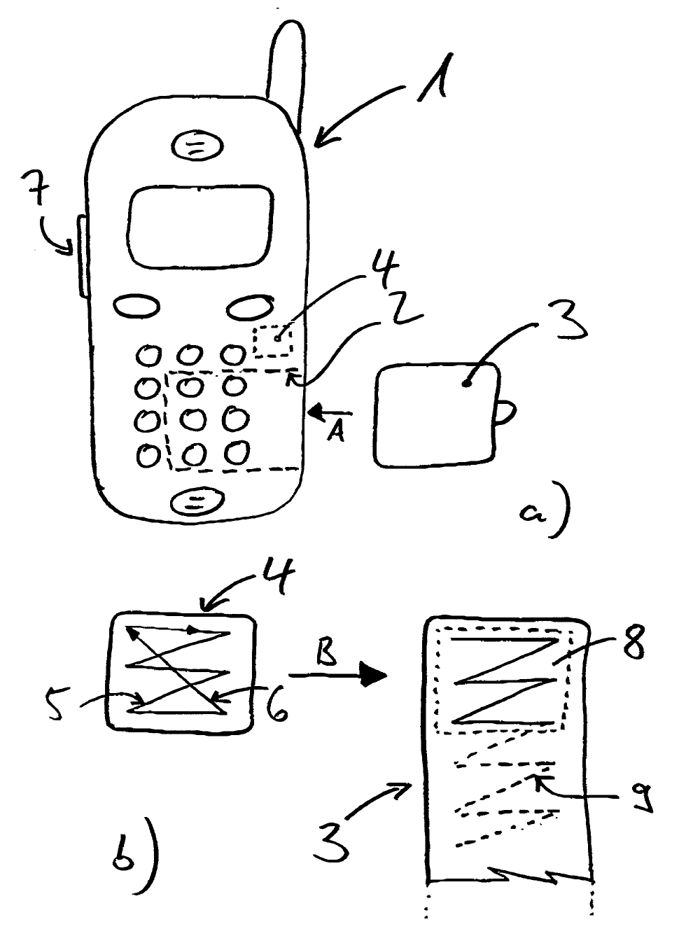

The present invention relates to a method for recording mobile-phone and in particular cell-phone conversations or fragments of conversation, said cell phone being fitted with a storage unit appropriate for recording and a writable memory. The invention furthermore relates to a cell phone suitable to carry out said method.

Cell phones comprising a memory storing fragments of conversation are known. Recording is implemented in that, during the conversation, by pressing a key actuating a storage unit comprising both a write and a read sub-unit, the corresponding memory will start loading. The capacity of the heretofore known memories suffices for instance to record a telephone number which is communicated during the conversation and which can be retrieved after the conversation has ended. Moreover memories of more substantial capacity are known which allow storing conversation fragments of a few minutes.

However their very limited capacity is a drawback of all storage units used in known cell phones. This restricted capacity entails starting recording at a given time which must be selected in such manner that the significant portions of the conversation shall be recorded. This time however being seldom accurately defined, the recording is likely to lack most of the critical portions of the conversation. If recording were to start automatically at the beginning of the conversation, there is a substantial danger of exhausting the memory capacity before getting to the conversation's critical matters. On the other hand, higher-capacity memories that might allow for instance an hour-long conversation, are inappropriate to cell phones because of their bulk and high power drain.

Accordingly it is the objective of the present invention to create a method which, in spite of the limited memory of cell phones, allows reliably recording the desired fragments of conversation and which is implemented using simple technical means. At the same time the goal of the present invention is to create a cell phone fit to implement said method.

These goals are attained by the method of claim 1 and the cell phone of claim 7.

The special advantages of the method of the invention result from the memory being a so-called scrolling memory continuously recording the conversation, the memory being written in cyclical scrolls that shall be specifically reset. The memory content represents a conversation fragment from beginning to end and is overwritten as soon as the memory is filled. The operation of such a memory is most simply represented as a continuously rotating roll of which the surface—following a full turn —will be loaded again. In especially advantageous manner, a scrolling memory always shall contain that portion of the elapsed conversation which can be stored in one revolution. Be it borne in mind in this respect that the scrolling operation need not be implemented by an actual rotation of a memory but also can be implemented electronically.

The advantage of the method of the invention is plain. Using very little storage capacity, it is possible to record the critical portions of a conversation. Moreover the method of the invention is economical and reliable. Comfort of use of the cell phone is increased when using the method of the invention and accordingly the phone's attractiveness is enhanced. With the method of the invention, the user at any time of a conversation and over the period of a cycle defining a given time-window will have access to the contents of the immediate past. The scrolling memory advantageously shall be volatile and operates in the manner of a known aviation voice-recorder.

In especially advantageous manner, the recording of the conversation into the scrolling memory shall be automatically started with the beginning of the conversation. In this case the user need not initially have to attend to recording while nevertheless being assured of retaining all information. On account of this automated start, further operating keys are not needed and hence the cell phone's manufacturing costs are reduced while operating convenience is increased. Also, the immediate start of recording as the conversation begins is easily implemented electronically.

In order to also store conversations longer than one cycle, advantageously the scrolling memory shall be associated with a long-term memory to which the contents from the scrolling memory may be transferred and which is able to record conversations of substantial length. In a particular embodiment and for that purpose, the invention provides the feature of enabling the user—at that time when it appears appropriate to record the conversation—to copy, by means of a command such as depressing a key, the total contents of the scrolling memory or the last 1, 2 or 3 minutes of the conversation into the long-term memory, and in an especially advantageous manner, the long-term memory then may record the ensuing conversation. In this manner the long-term memory assumes the function of recording the conversation and the method of the invention secures the recording of the portion of the conversation preceding the time at which the decision was taken.

The contents of the long-term memory can be read out following recording. Said contents either may be listened to, or, in an advantageous embodiment, may be copied by means of an interface, for instance an infrared interface, onto an external memory. Illustrative external memories are such media as magnetic tapes or optic disks (CDS) or PCS.

Furthermore the long-term memory can be a writable solid-state storage in the form of a memory card so that it can be removably inserted into a corresponding slot of the cell phone. Such a memory card can be exchanged at will. Using such memory cards, a long conversation may be recorded on several consecutively inserted cards, the transitions being bridged as desired by the scrolling memory.

Advantageously the scrolling memory shall be a volatile solid state memory for instance in the form of a RAM. The capacity of the scrolling memory preferably is slightly less than one megabyte so that the recorded conversation cycles are a few minutes long. The appropriate operation of the scrolling memory will be assured using such a time span.

Advantageously and on account of its low costs compared with the known solutions of expensive business phones, the method of the invention also is applicable to low-cost phones for private use.

The attached Figure shows an illustrative embodiment of the present invention and elucidated below.

Part a) of the Figure shows a conventional cell phone 1. This cell phone 1 is fitted with an insertion compartment 2 to accept a writable card-like, solid-state memory 3 (arrow A). A writable, scrolling memory 4 also in the form of a RAM chip is mounted in the actual cell phone. The scrolling memory 4 and the solid-state memory 3 jointly with the associated write-and-read module constitute a compact storage unit which in an especially advantageous embodiment is operated in a cell phone.

The operation of the scrolling memory 4 is illustrated by the portion b) of said Figure. The storage space of the scrolling memory 4 is loaded line by line along the time base 5 as the conversation proceeds, the time base 5 when reaching the end of the storage space being reset by means of a diagonal deflection 6 to the start position. The closed time base 5 determines a cycle of a specified duration. When a cycle is terminated, a reset is written on the memory 4 and the previous storage content shall be overwritten after one cycle. The conversation is automatically recorded from its beginning on the scrolling memory.

By depressing a key 7, the cell-phone's user may command the storage to copy the content 8 of the scrolling memory 4 onto the solid-state memory 3 (arrow B). After the copying procedure has been initiated by the user, the subsequent conversation 9 is continuously loaded into the long-term memory. The content of the long-term memory can be read, and in particular be listened to, at a later time.

In another embodiment mode, each depression of the key corresponds to one minute backward. If therefore the user depresses the key three times, the last three minutes of conversation are copied into the non-volatile memory and next the further conversation shall be recorded permanently.

1. A method for recording conversations and/or fragments of conversations during mobile, and in particular cell-phone conversations, said phone comprising a storage unit with a writable memory,
characterized in that
the memory is a scrolling memory loaded in cycles of specified resets and where the memory contents are overwritten after once cycle.

2. Method as claimed in claim 1, characterized in that said recording starts automatically in the scrolling memory as the conversation begins.

3. Method as claimed in either of claims 1 and 2, characterized in that upon action by the user, for instance by depressing a key, a portion of or all the contents of the scrolling memory shall be loaded into a long-term memory.

4. Method as claimed in claim 3, characterized in that upon action by the user, the subsequent conversation shall be loaded into the long-term memory.

5. Method as claimed in one of the above claims, characterized in that the contents of the long-term memory are retrieved from the long-term memory and in particular shall be listened to.

6. Method as claimed in one of the above claims, characterized in that the contents of the long-term memory are transmitted by means of an interface to a memory external to the cell phone.

7. Method as claimed in one of the above claims, characterized in that the scrolling memory and the long-term memory are integrated into one physical storage unit.

8. A mobile, in particular a cell phone fitted with a storage unit recording conversation or fragments of conversations,
characterized in that
the storage unit is fitted with a writing module writing into a memory in scrolling manner in cycles of specified resets.

9. Cell phone as claimed in claim 8, characterized in that the scrolling memory is a magnetic memory.

10. Cell phone as claimed in claim 9, characterized in that the scrolling memory is a solid-state memory in the form of a writable RAM.

11. Cell phone as claimed in one of claims 8 through 10, characterized in that the capacity of the scrolling memory is less than one megabyte.

12. Cell phone as claimed in one of claims 8 through 11, characterized in that the cycles each last a few minutes.
